(19) United States
(12) Patent Application Publication
(10) Pub. No.: US 2025/0385872 A1
(43) Pub. Date: Dec. 18, 2025

(54) SYSTEMS AND METHODS FOR CONNECTION MANAGEMENT

(71) Applicant: Comcast Cable Communications, LLC, Philadelphia, PA (US)

(72) Inventors: Chae Chung, Philadelphia, PA (US); Saravanan Muthusamy, Wayne, PA (US); Richard Woundy, Philadelphia, PA (US)

(21) Appl. No.: 18/741,622

(22) Filed: Jun. 12, 2024

(51) Int. Cl. H04L 47/2483; H04L 47/2491

(52) U.S. Cl. CPC H04L 47/2483; H04L 47/2491

(57) ABSTRACT

Methods and systems for connection management are disclosed. A service entity may provide preferential treatment to a group of devices on a network. To identify itself as being entitled to receive such treatment, a user device may send one or more credentials to a server device associated with the service entity. The credential(s) may be used to determine if the user device belongs to the group of devices. If the user device belongs to the group of devices, the service entity may establish one or more enhanced service flows that the user device can use to communicate with and/or over the network.

### BACKGROUND

A network can comprise one or more network devices that enable user devices to communicate with and/or over the network. A network device can comprise a device that allows wired and/or wireless user devices to connect to the network using Wi-Fi, Bluetooth, or related technologies. However, network performance issues, such as congestion, can negatively impact the ability of the user devices to communicate with and/or over the network. These and other shortcomings are addressed by the present disclosure.

### SUMMARY

Methods, systems, and devices for connection management are disclosed. A service entity may agree to provide preferential treatment, using congestion-free service flows, to a group of devices on a network. But, in a complex network, some devices may use different device identifiers (e.g., a media access control address, or other physical address or hardware address) at different times. The use of such temporary device identifiers may make it difficult to identify the devices belonging to this group. As such, instead of identifying itself as belonging to the group using a device identifier, a user device that has connected to the network via a local network device may identify itself as belonging to the group using two different credentials. A first of the two credentials may be used to verify that the user device belongs to the group. If the first credential indicates that the user device belongs to the group, the second of the two credentials may be used to verify that the local network device is associated with the service entity. If the second credential indicates that the local network device is associated with the service entity, a service flow may be provisioned for the user device. The service flow may be free of congestion caused by other devices (e.g., devices not belonging to the group) on the network. The user device may use the service flow to communicate with and/or over the network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example flow diagram.

FIG. 3 is an example table.

FIG. 4 is an example method.

FIG. 5 is an example method.

FIG. 6 is an example method.

FIG. 7 is an example computing device.

### DETAILED DESCRIPTION OF ILLUSTRATIVE EMBODIMENTS

Methods and systems for connection management are disclosed. A service entity (e.g., service provider) may provide one or more services to a user device over a network. The one or more services can include voice services (e.g., telephone, etc.), video services (e.g., television, etc.) and data services (e.g., Internet, etc.). However, excessive demand for access to the network can cause network performance issues, such as congestion, that negatively impact the ability of the user device to receive the one or more services.

A service entity may want to prevent subscribers (e.g., customers, clients), or at least a portion of subscribers, from experiencing such network performance issues. To prevent its subscribers (or a portion of its subscribers) from experiencing such network performance issues, a service entity can provide enhanced (e.g., special, preferential) treatment to a group (e.g., subset) of devices on the network. The group of devices to which the service entity provides the enhanced treatment can include all of the service entity's subscribers or a subset of the service entity's subscribers.

A user device at a premises can identify itself as belonging to the group of devices by sending a message to a server device associated with the service entity. The message can indicate a subscriber identifier (e.g., international mobile subscriber identity (IMSI)) associated with the user device and a network address (e.g., internet protocol (IP) address, IPv6 address) associated with the user device. Based on the subscriber identifier, the server device can determine if the user device belongs to the group of devices. If the server device verifies that the user device belongs to the group of devices, the server device may send the network address associated with the user device to a second network device (e.g., access gateway device) located external to the premises.

Based on the network address associated with the user device, the second network device can determine (e.g., derive) a network address (e.g., internet protocol (IP) address, IPv6 address) associated with a first network device located at the premises. The second network device can determine if the first network device is associated with the service entity based on the network address associated with the first network device. If the second network device verifies that the first network device is associated with the service entity, one or more enhanced service flows can be provisioned between the user device and the second network device. The enhanced service flows(s) can be associated with one or more enhanced services, such as an increased download speed, increased upload speed, a spam filtering service, a malware detection service, a parental control service that limits access to certain types of content or content sources, and/or any other type of enhanced service.

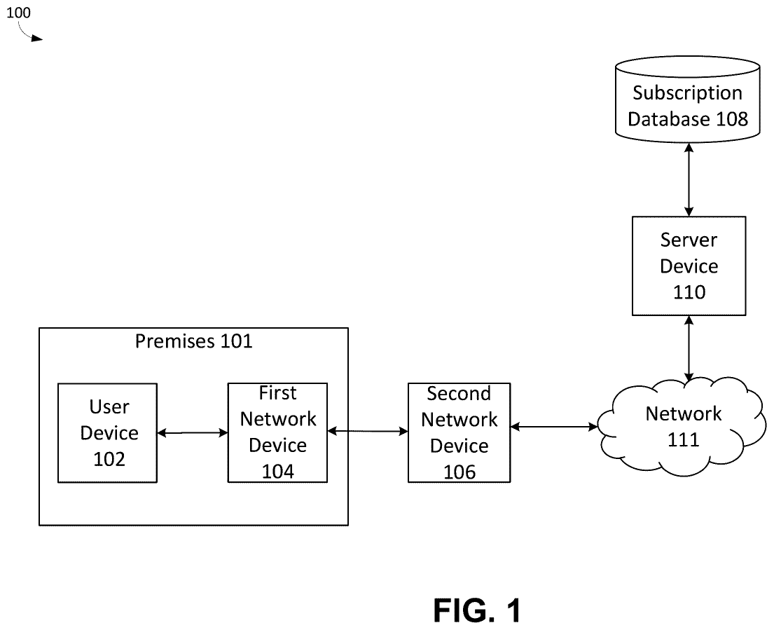

FIG. 1 shows a block diagram of an example system 100. The system 100 may comprise a user device 102, a first network device 104 (e.g., router device, gateway device, computing device, access point, etc.), a second network device 106 (e.g., gateway device, computing device, access point, etc.), a server device 110, a subscription database 108, and a network 111. It should be noted that while the singular term device is used herein, it is contemplated that some devices may be implemented as a single device or a plurality of devices (e.g., via load balancing). The user device 102, the first network device 104, the second network device 106, the server device 110, the subscription database 108, and the network 111 may each be implemented as one or more computing devices. Any device disclosed herein may be implemented using one or more computing nodes, such as virtual machines, executed on a single device and/or multiple devices.

The network 111 may comprise a service entity, content provider (e.g., distributor) and/or access network. The network 111 may facilitate communication via one or more communication protocols. The network 111 may comprise any of a variety of types of networks, such as, for example, a coaxial cable network, a fiber-optic cable network, a hybrid fiber-coaxial (HFC) network, a satellite transmission channel, a DSL connection, or the like. The network 111 may comprise fiber, cable, a combination thereof. The network 111 may comprise wired links, wireless links, a combination thereof, and/or the like. The network 111 may comprise routers, switches, nodes, gateways, servers, modems, and/or the like. The network 111 may comprise one or more networks, such as a wide area network (e.g., the Internet), a cellular network, a Long Term Evolution (LTE) network, one or more service entity networks, and/or the like. The network 111 may be a converged network, having capabilities to route traffic over various communication networks, such as a cellular network, a Wi-Fi network, etc.

The user device 102 and the first network device 104 may be located at a premises 101. The premises 101 may comprise a property, dwelling, terminal, building, floor, and/or the like. The premises 101 may comprise different rooms, walls, door, windows, and/or the like. The premises 101 may include an area within a coverage range (e.g., wireless range) of the first network device 104. The user device 102 and/or and the first network device 104 may move within and/or outside the premises 101. The user device 102 and/or and the first network device 104 may be fixed at a stationary location within the premises 101. The user device 102 may comprise a computing device, a smart device (e.g., smart glasses, smart watch, smart phone), a mobile device, a tablet, a computing station, a laptop, a digital streaming device, a streaming stick, a television, and/or the like. The first network device 104 may comprise a gateway device, a router device, or a modem.

The user device 102 may cause establishment of a connection with the first network device 104. To cause establishment of the connection with the first network device 104, the user device 102 may send data associated with establishing the connection to the first network device 104. The data may indicate a device identifier associated with the user device 102. The device identifier may comprise a media access control (MAC) address, such as a Wi-Fi MAC address, associated with the user device 102. The first network device 104 may establish the connection with the user device 102 based on the data.

The device identifier may comprise a temporary device identifier (e.g., randomized MAC address, rotating MAC address, pseudo MAC address, etc.). The device identifier may not be a user identifier. The device identifier may be identified as (e.g., in a specific field, formatted as) a hardware identifier, a permanent identifier, a media access control identifier, and/or the like. The device identifier may comprise (e.g., and in some scenarios may be identified as) a temporary identifier, a randomized identifier, a generated identifier (e.g., generated by the user device 102), and/or the like. The device identifier may be a persistent identifier (e.g., persistent for a specific network from one session to another). The device identifier may be generated by the user device 102. The user device 102 may be configured to associate (e.g., and determine, generate) different device identifiers with different identity information corresponding to one or more different networks, service entities, or network devices on different networks. If the device identifier comprises a temporary device identifier, the data sent to establish the connection with the first network device 104 may indicate the current device identifier of the user device 102.

The first network device 104 may be connected to the second network device 106 (e.g., via a HFC connection). The second network device 106 may comprise a gateway device (e.g., access gateway device), a termination system (e.g., cable modem termination system (CMTS)), a terminal, a fiber node, a network end point, a digital subscriber line access multiplexer (DSLAM), or an optical line terminal (OLT). The second network device 106 may be located at a headend of the service entity. The second network device 106 may be configured to provide high speed data services, such as cable Internet or Voice over Internet Protocol or IP Video, to the user device 102. The second network device 106 may be connected to the network 111. Thus, the user device 102 may establish a connection with the network 111 based on establishing the connection with the first network device 104.

The user device 102 may send a message to the server device 110. The user device 102 may send the message to the server device 110 to identify itself as belonging to a group of devices on the network 111 to which the service entity provides preferential treatment (e.g., one or more enhanced service flows). The user device 102 may send the message to the server device 110 based on establishing the connection with the network 111.

The user device 102 may send the message to the server device 110 based on determining a location (e.g., address) of the server device 110. Determining the location of the server device 110 may comprise sending a request (e.g., discovery request) for a mobile carrier identifier. The user device 102 may send the request (e.g., discovery request) for the mobile carrier identifier to a server device (not shown in FIG. 1), such as an entitlement server. The user device 102 may receive data indicating the location (e.g., address) of the server device 110 based on (e.g., in response to) sending the request. The user device 102 may receive the data indicating the location (e.g., address) of the server device 110 from the server device (e.g., the entitlement server). Determining the location of the server device 110 may comprise determining the location of the server device 110 based on a subscriber identity module (SIM) card associated with the user device 102. Data indicating the location of server device 110 may be stored on the SIM card, which may be a physical SIM card or a digital SIM card. Determining the location of the server device 110 may comprise determining the location of the server device 110 based on an existing configuration protocol, such as DHCP or DHCPv6. Determining the location of the server device 110 may comprise determining a location of the server device 110 that is independent of the service entity. The network 111 may use a special DNS resolution (e.g., to an address specific to the service entity) or use anycast forwarding to deliver messages from user device 102 to server device 110. The user device 102 may send the message to the server device 110 based on the location.

The message may be indicative of a subscriber identifier (e.g., mobile user identifier, carrier identifier, cellular identifier, mobile subscriber identifier, etc.) associated with the user device 102. The subscriber identifier can comprise an IMSI associated with the user device 102. The IMSI may be stored on a subscriber identity module (SIM) card, such as an eSIM or a physical SIM card, associated with (e.g., stored on) the user device 102. The message may be indicative of a network address associated with the user device 102. The network address associated with the user device 102 may comprise an IP address, such as an IPV6 address, of the user device 102. The message may comprise a body (e.g., data payload) and header data. The body of the message may comprise the subscriber identifier. The body of the message may comprise the device identifier, such as the current device identifier, of the user device 102. The header data may comprise the network address associated with the user device 102.

The server device 110 may receive the message. The server device 110 may receive the message from the user device 102. The server device 110 may determine if the user device 102 is associated with (e.g., belongs to) the group of devices on the network 111 to which the service entity provides preferential treatment (e.g., one or more enhanced service flows). The server device 110 may determine if the user device 102 is associated with the group of devices based on the subscriber identifier (e.g., the IMSI) of the user device 102. To determine if the user device 102 is associated with the group of devices, the server device 110 may determine if the subscriber identifier of the user device 102 corresponds to the service entity. Determining if the subscriber identifier of the user device 102 corresponds to the service entity may comprise comparing the subscriber identifier to subscription data stored in the subscription database 108. The subscription data stored in the subscription database 108 may comprise data indicating the subscribers (e.g., customers, clients) of the service entity and/or the subscription(s) associated with the subscribers. The server device 110 may determine that the user device 102 is associated with the group of devices if the subscriber identifier corresponds to a subscriber of the service entity and/or if the subscriber identifier corresponds to at least one subscription, subscription tier, communication service, mobile calling service, etc. associated with the service entity.

If the server device 110 determines that the user device 102 is associated with the group of devices, the server device 110 may determine one or more service flow identifier(s) associated with the enhanced service flow(s) to be provisioned for the user device 102. The server device 110 may determine the service flow identifier(s) based on the subscriber identifier of the user device 102. The server device 110 may determine the service flow identifier(s) based on the subscription(s) associated with the subscriber identifier of the user device 102. The server device 110 may send data indicating the service flow identifier(s) to the second network device 106. The server device 110 may send the data indicating the service flow identifier(s) to the second network device 106 based on (e.g., in response to) determining that the user device 102 is associated with the group of devices.

The server device 110 may send data indicating the network address associated with the user device 102 to the second network device 106. The server device 110 may send the data indicating the network address associated with the user device 102 to the second network device 106 based on (e.g., in response to) determining that the user device 102 is associated with the group of devices.

The second network device 106 may receive a message. The second network device 106 may receive the message from the server device 110. The message received from the server device 110 may comprise the network address associated with the user device 102. The message received from the server device 110 may comprise the service flow identifier(s) associated with establishment of the enhanced service flow(s).

The second network device 106 may determine (e.g., derive) a network address associated with the first network device 104 based on the network address associated with the user device 102. The second network device 106 may determine if the first network device 104 is associated with the service entity. The second network device 106 may determine if the first network device 104 is associated with the service entity based on determining if the first network device 104 is associated with (e.g., belongs to) the group of devices on the network 111 to which the service entity provides preferential treatment (e.g., enhanced service flows). The second network device 106 may determine if the first network device 104 is associated with the service entity based on the network address associated with the first network device 104. Determining if the first network device 104 is associated with the service entity may comprise determining if the network address associated with the first network device 104 is associated with a device that has been issued by the service entity.

If the first network device 104 is associated with the service entity, the second network device 106 may establish at least one enhanced service flow (e.g., connection) between the second network device 106 and the first network device 104. The second network device 106 may establish the at least one enhanced service flow based on the service flow identifier(s). The service flow identifier(s) may indicate one or more parameters associated with the at least one enhanced service flow. The parameter(s) may specify the maximum download and/or upload speed, QoS parameters, and/or direction.

The at least one enhanced service flow may comprise a first enhanced service flow associated with upstream traffic (e.g., data sent from the first network device 104 to the second network device 106) and a second enhanced service flow associated with downstream traffic (e.g., traffic sent from the second network device 106 to the first network device 104). The service flow identifier(s) may comprise an upstream service flow identifier associated with the first enhanced service flow and a downstream service flow identifier associated with the second enhanced service flow. The upstream service flow identifier may indicate one or more parameters associated with the first enhanced service flow. The downstream service flow identifier may indicate one or more parameters associated with the second enhanced service flow. The second network device 106 may establish the first enhanced service flow based on the upstream service flow identifier. The second network device 106 may establish the first enhanced service flow based on sending data indicating the upstream service flow identifier to the first network device 104. The first network device 104 may use the data indicating the upstream service flow identifier to establish the first enhanced service flow. The second network device 106 may establish the second enhanced service flow based on the downstream service flow identifier.

The at least one enhanced service flow may be a “fast lane” (e.g., channel) that is free of congestion caused by other devices connected to the second network device 106. The at least one enhanced service flow may be associated with at least one enhanced service provided by the service entity. The enhanced service(s) may comprise an increased download speed and/or an increased upload speed, such as a download and/or upload speed of 200 megabits per second (Mbps), 300 Mbps, 400 Mbps, 500 Mbps, etc. The enhanced service(s) may comprise a spam filtering service and/or malware detection service. The enhanced service(s) may comprise a parental control service that limits access to certain types of content or content sources. Other devices that are connected to the second network device 106 but that do not receive preferential treatment from the service entity may not be able to take advantage of the enhanced service(s) provided via the local enhanced service flow(s). For example, other devices that are connected to the second network device 106 but that do not receive preferential treatment from the service entity may only receive a download and/or upload speed of 50 Mbps. As another example, other devices that are connected to the second network device 106 but that do not receive preferential treatment from the service entity may not have access to the spam filtering service, malware detection service, and/or parental control service.

The second network device 106 may store an association between the first network device 104 and the at least one enhanced service flow. The second network device 106 may store an association between the first network device 104 and the at least one enhanced service flow based on establishing the at least one enhanced service flow between the second network device 106 and the first network device 104. The second network device 106 may determine a device identifier, such as a MAC address, associated with the first network device 104 based on the network address associated with the first network device 104. If the first network device 104 is associated with a temporary device identifier, such as a randomized MAC address or a rotating MAC address, the second network device 106 may determine a current MAC address associated with the first network device 104 based on an IPV6 address of the first network device 104. The second network device 106 may store an association between the device identifier (e.g., current device identifier) of the first network device 104 and the at least one enhanced service flow. The second network device 106 may use the stored association between the device identifier of the first network device 104 and the at least one enhanced service flow to ensure that data being sent to the device identifier of the first network device 104 is sent via the at least one enhanced service flow, and that data being sent from the device identifier of the first network device 104 is sent via the at least one enhanced service flow.

The first network device 104 may establish at least one local enhanced service flow (e.g., connection) between the first network device 104 and the user device 102. The first network device 104 may establish the local enhanced service flow(s) between the first network device 104 and the user device 102 based on the device identifier (e.g., current device identifier) of the user device 102. The local enhanced service flow(s) between the first network device 104 and the user device 102 may comprise a first enhanced service flow associated with upstream traffic (e.g., data sent from the user device 102 to the first network device 104) and a second enhanced service flow associated with downstream traffic (e.g., traffic sent from the first network device 104 to the user device 102).

The local enhanced service flow(s) may be a “fast lane” (e.g., channel) that is free of congestion caused by other devices at the premises connected to the first network device 104. The local enhanced service flow(s) may be associated with at least one enhanced service. The enhanced service(s) may comprise an increased download speed and/or an increased upload speed, such as a download and/or upload speed of 200 megabits per second (Mbps), 300 Mbps, 400 Mbps, 500 Mbps, etc. The enhanced service(s) may comprise a spam filtering service and/or malware detection service. The enhanced service(s) may comprise a parental control service that limits access to certain types of content or content sources. Other devices at the premises that are connected to the first network device 104 but that do not receive preferential treatment from the service entity may not be able to take advantage of the enhanced service(s) provided via the local enhanced service flow(s). For example, other devices at the premises that are connected to the first network device 104 but that do not receive preferential treatment from the service entity may only receive a download and/or upload speed of 50 Mbps. As another example, other devices at the premises that are connected to the first network device 104 but that do not receive preferential treatment from the service entity may not have access to the spam filtering service, malware detection service, and/or parental control service.

The first network device 104 may store an association between the user device 102 and the local enhanced service flow(s). The first network device 104 may store an association between the user device 102 and the local enhanced service flow(s) based on establishing the local enhanced service flow(s) between the first network device 104 and the user device 102. The first network device 104 may store an association between the device identifier (e.g., current device identifier) of the user device 102 and the local enhanced service flow(s). The first network device 104 may use the stored association between the current device identifier of the user device 102 and the local enhanced service flow(s) to ensure that data being sent to the current device identifier of the user device 102 is sent via the local enhanced service flow(s), and that data being sent from the current device identifier of the user device 102 is sent via the local enhanced service flow(s).

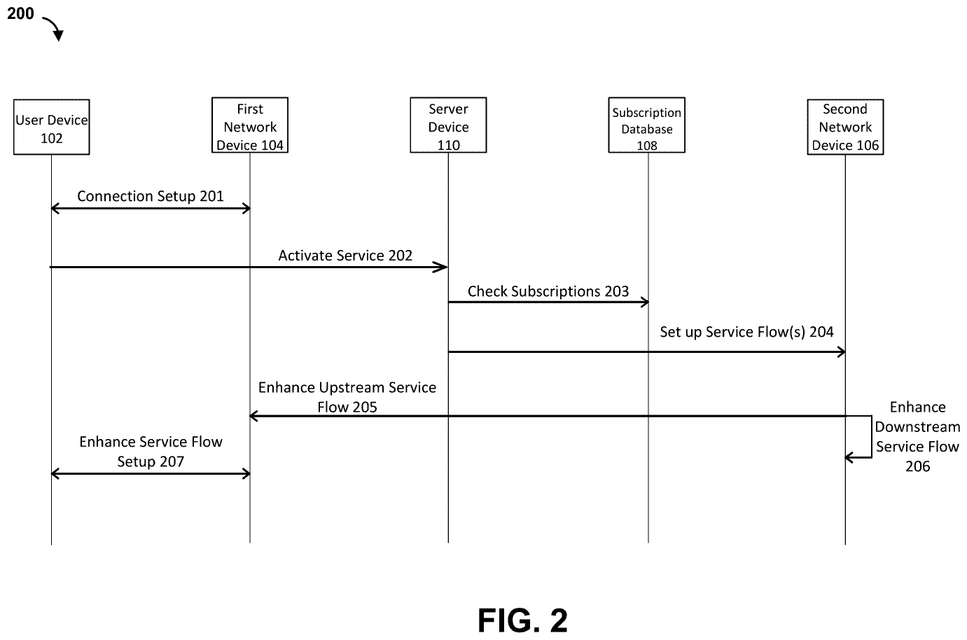

FIG. 2 is an example flow diagram 200. The flow diagram 200 shows a process for establishing enhanced service flow(s). At 201, a connection may be set up between the user device 102 and the first network device 104. The user device 102 may initiate or cause establishment of the connection with the first network device 104. To initiate or cause establishment of the connection with the first network device 104, the user device 102 may send data associated with establishing the connection to the first network device 104. The data may indicate a device identifier, such as a MAC address (e.g., Wi-Fi MAC address), associated with the user device 102. If the user device 102 is associated with a temporary device identifier, such as a randomized MAC address or a rotating MAC address, the user device 102 may send data indicating the current device identifier of the user device 102 to the first network device 104. The first network device 104 may establish the connection with the user device 102 based on the data. The first network device 104 may be connected to the second network device 106 (e.g., via a HFC connection). The second network device 106 may be connected to the network 111. Thus, the user device 102 may establish a connection with the network 111 based on establishing the connection with the first network device 104.

At 202, the user device 102 may send a message to the server device 110. The user device 102 may send the message to the server device 110 based on establishing the connection with the network 111. The message may be indicative of a subscriber identifier (e.g., an IMSI) associated with the user device 102. The message may be indicative of a network address associated with the user device 102. The network address associated with the user device 102 may comprise an IP address, such as an IPV6 address, of the user device 102.

The server device 110 may receive the message. The server device 110 may receive the message from the user device 102. The server device 110 may determine if the user device 102 is associated with (e.g., belongs to) a group of devices on the network 111 to which the service entity provides preferential treatment (e.g., one or more enhanced service flows) based on the subscriber identifier (e.g., the IMSI) of the user device 102. To determine if the user device 102 is associated with the group of devices, the server device 110 may determine if the subscriber identifier of the user device 102 corresponds to the service entity.

Determining if the subscriber identifier of the user device 102 corresponds to the service entity may comprise comparing the subscriber identifier to subscription data stored in the subscription database 108. At 203, the server device 110 may comparing the subscriber identifier to subscription data stored in the subscription database 108. The subscription data stored in the subscription database 108 may comprise data indicating the subscribers (e.g., customers, clients) of the service entity and/or the subscription(s) associated with the subscribers. The server device 110 may determine that the user device 102 is associated with the group of devices if the subscriber identifier corresponds to a subscriber of the service entity and/or if the subscriber identifier corresponds to at least one subscription associated with the service entity.

If the server device 110 determines that the user device 102 is associated with the group of devices, the server device 110 may send a message to the second network device 106. At 204, the server device 110 may send a message to the second network device 106. The message may comprise data indicating the network address associated with the user device 102. The message may comprise service flow identifier(s) associated with establishment of one or more enhanced service flows.

The second network device 106 may receive the message. The second network device 106 may receive the message from the server device 110. The second network device 106 may determine if the first network device 104 is associated with (e.g., belongs to) the group of devices to which the service entity provides preferential treatment (e.g., enhanced service flows). The second network device 106 may determine (e.g., device) a network address associated with the first network device 104 based on the network address associated with the user device 102. The second network device 106 may determine if the first network device 104 is associated with the group of devices based on the network address associated with the first network device 104. Determining if the first network device 104 is associated with the service entity may comprise determining if the network address associated with the first network device 104 is associated with a device that has been issued by the service entity.

If the first network device 104 is associated with the service entity, the second network device 106 may establish at least one enhanced service flow (e.g., connection) between the second network device 106 and the first network device 104. The second network device 106 may establish the at least one enhanced service flow based on the service flow identifier(s). The at least one enhanced service flow may comprise a first enhanced service flow associated with upstream traffic (e.g., data sent from the first network device 104 to the second network device 106). At 205, the first enhanced service flow associated with upstream traffic may be established. The service flow identifier(s) may comprise an upstream service flow identifier associated with the first enhanced service flow. The first enhanced service flow may be established based on the upstream service flow identifier. The second network device 106 may establish the first enhanced service flow based on sending data indicating the upstream service flow identifier to the first network device 104. The first network device 104 may use the data indicating the upstream service flow identifier to establish the first enhanced service flow.

The at least one enhanced service flow may comprise a second enhanced service flow associated with downstream traffic (e.g., traffic sent from the second network device 106 to the first network device 104). At 206, the second enhanced service flow associated with downstream traffic may be established. The service flow identifier(s) may comprise a downstream service flow identifier associated with the second enhanced service flow. The second network device 106 may establish the second enhanced service flow based on the downstream service flow identifier.

The first and/or second service flows may be “fast lanes” (e.g., channels) that are free of, or substantially free of, congestion caused by other devices. The first and/or second service flows may be associated with at least one enhanced service provided by the service entity. The enhanced service(s) may comprise an increased download speed and/or an increased upload speed, such as a download and/or upload speed of 200 megabits per second (Mbps), 300 Mbps, 400 Mbps, 500 Mbps, etc. The enhanced service(s) may comprise a spam filtering service and/or malware detection service. The enhanced service(s) may comprise a parental control service that limits access to certain types of content or content sources.

At 207, at least one local enhanced service flow (e.g., connection) between the first network device 104 and the user device 102 may be established. The first network device 104 may establish the at least one local enhanced service flow (e.g., connection) between the first network device 104 and the user device 102. The first network device 104 may establish the local enhanced service flow(s) between the first network device 104 and the user device 102 based on the device identifier (e.g., current device identifier) of the user device 102. The local enhanced service flow(s) between the first network device 104 and the user device 102 may comprise a first enhanced service flow associated with upstream traffic (e.g., data sent from the user device 102 to the first network device 104) and a second enhanced service flow associated with downstream traffic (e.g., traffic sent from the first network device 104 to the user device 102). The local enhanced service flow(s) may be a “fast lane” (e.g., channel) that is free of congestion caused by other devices at the premises connected to the first network device 104. The local enhanced service flow(s) may be associated with at least one enhanced service, such as an increased download speed and/or an increased upload speed, a spam filtering service, a malware detection service, or a parental control service that limits access to certain types of content or content sources.

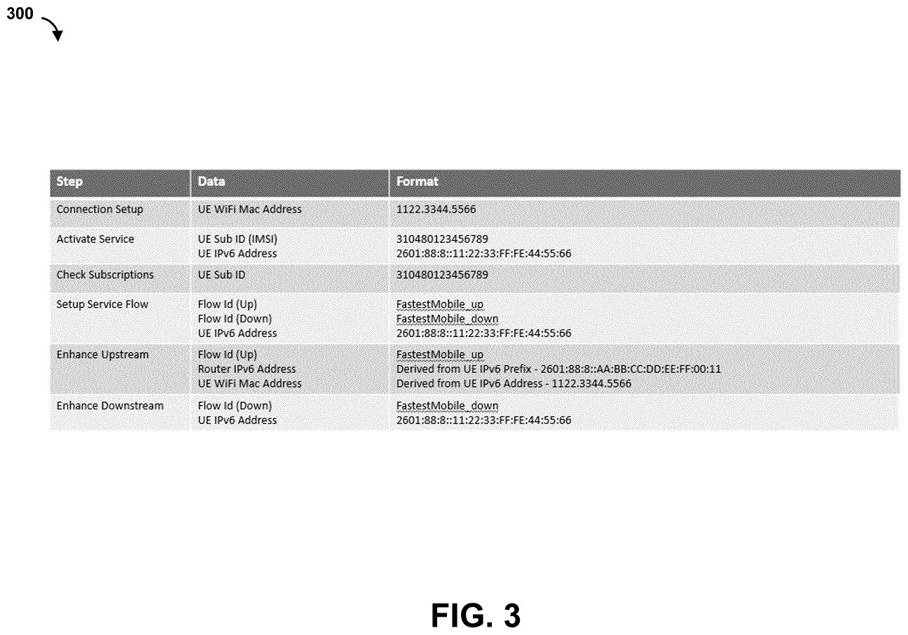

FIG. 3 is an example table 300. The table 300 shows example types of data and example formats of the data sent between the components of the system 100 during the process shown in the flow diagram 200. At 201 (e.g., connection set up step), the user device 102 may send a device identifier (e.g., current device identifier) of the user device 102 to the first network device 104. The device identifier may comprise a MAC address having the format “1112.3344.5566.” The first network device 104 may use the device identifier of the user device 102 to establish the initial connection between the user device 102 and the first network device 104. At 202 (e.g., activate service step), the user device 102 can send a message comprising the IMSI of the user device 102 and the IP address (e.g., IPv6 address) of the user device 102. The IMSI may comprise up to fifteen digits (e.g., 310480123456789). The IP address of the user device 102 may have the format “2601:88:8::11:22:33:FF:FE:44:55:66.” At 203 (e.g., check subscriptions step), to determine if the user device 102 is associated with the group of devices, the server device 110 may compare the IMSI to subscription data stored in the subscription database 108.

At 204 (e.g., set up service flow step), the server device 110 may send a message to the second network device 106. The message sent to the second network device 106 may comprise the IP address (e.g., IPv6 address) of the user device 102 and the service flow identifier(s) associated with establishment of one or more enhanced service flows. The server device 110 may determine the IP address (e.g., IPv6 address) of the first network device 104 based on the IP address (e.g., IPv6 address) of the user device 102. At 205 (e.g., enhance upstream service flow step), the second network device 106 may set up the upstream service flow based on the IP address (e.g., IPv6 address) of the first network device 104, the service flow identifier associated with the upstream service flow, and the device identifier (e.g., current device identifier) of the user device 102. For example, the second network device 106 may cause the upstream service flow to be set up based on sending the service flow identifier associated with the upstream service flow and/or the device identifier of the user device 102 to the IP address (e.g., IPv6 address) of the first network device 104. At 206 (e.g., enhance downstream service flow step), the second network device 106 may set up the downstream service flow based on the IP address (e.g., IPv6 address) of the user device 102 and the service flow identifier associated with the downstream service flow.

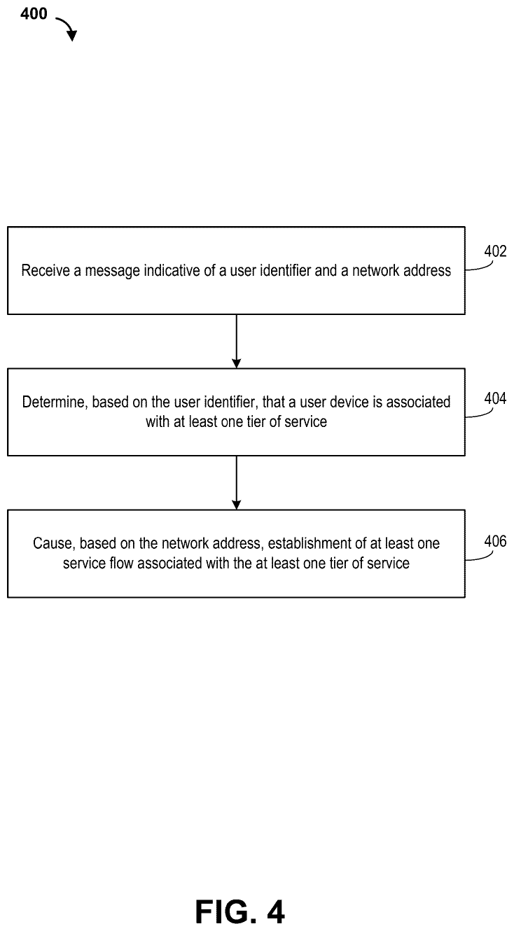

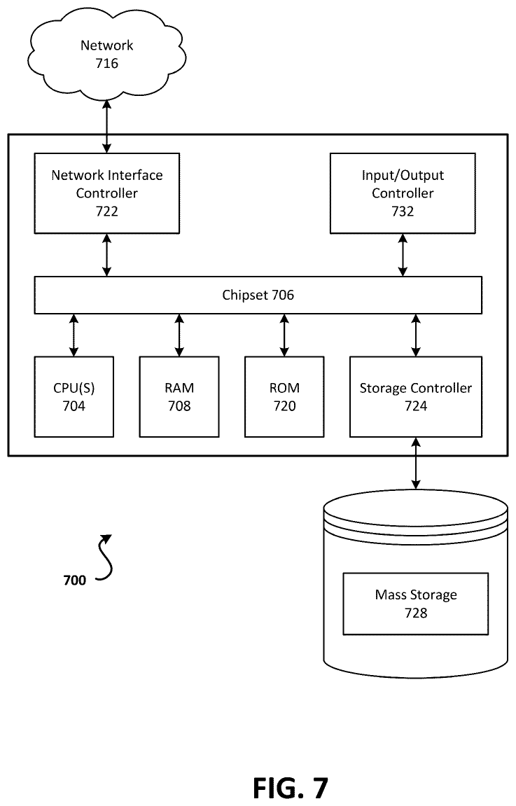

FIG. 4 is an example method 400. The method 400 may comprise a computer implemented method for connection management. A computing device, a system and/or computing environment, such as the system 100 of FIG. 1 and/or the computing environment of FIG. 7, may be configured to perform the method 400. For example, the server device 110 of FIG. 1 may be configured to perform the method 400.

At 402, a message may be received. The message may be received from a user device. The user device may be located at a premises. The message may be indicative of a user identifier associated with the user device. The user identifier can comprise a subscriber identifier, such as an IMSI, associated with the user device. The IMSI may be stored on a SIM card, such as an eSIM or a physical SIM card, associated with the user device. The message may be indicative of a network address associated with a first network device. For example, the message may comprise data indicating a network address associated with the user device. The network address associated with the user device may be indicative of the network address associated with a first network device. The first network device may be located at the premises. The user device may be connected to the first network device. The network address associated with the first network device may comprise an IP address, such as an IPV6 address, of the first network device.

At 404, it may be determined that the user device is associated with at least one tier of service. Determining that the user device is associated with the at least one tier of service may comprise determining that the user device is associated with (e.g., belongs to) a group of devices associated with at least one enhanced service. For example, it may be determined that the user device is associated with a group of devices on a network to which a service entity provides preferential treatment (e.g., one or more enhanced service flows). It may be determined that the user device is associated with the at least one type of service based on the subscriber identifier.

Determining that the user device is associated with the at least one type of service may comprise determining that the user identifier corresponds to the service entity. Determining if the user identifier of the user device corresponds to the service entity may comprise comparing the user identifier to data stored in a database associated with the service entity. The data stored in the database may comprise data indicating the subscribers (e.g., customers, clients) of the service entity and/or the subscription(s) associated with the subscribers. The computing device may determine that the user device is associated with the at least one tier of service if the user identifier corresponds to a subscriber of the service entity and/or if the subscriber identifier corresponds to at least one subscription associated with the service entity.

At 406, establishment of at least one service flow (e.g., connection) between the user device and a second network device may be caused. The second network device may be located external to the premises. Establishment of the at least one service flow between the user device and the second network device may be caused based on the user device being associated with the at least one tier of service. The at least one service flow may comprise a first service flow associated with upstream traffic (e.g., data sent from the user device/first network device to the second network device) and a second service flow associated with downstream traffic (e.g., traffic sent from the second network device to the user device/first network device). The at least one service flow may be a “fast lane” (e.g., channel) that is free of congestion caused by other devices connected to the first network device and/or the second network device. The at least one service flow may be associated with at least one tier of service provided by the service entity. The at least one tier of service may be associated with one or more enhanced services, such as an increased download speed, an increased upload speed, a spam filtering service, a malware detection service, and/or a parental control service that limits access to certain types of content or content sources. Other devices that are connected to the first network device and/or the second network device but that do not receive preferential treatment from the service entity may not be able to take advantage of the enhanced service(s) provided via the at least one service flow.

Establishment of the at least one service flow between the user device and the second network device may be caused based on the network address associated with the first network device. The network address associated with the first network device may be sent to the second network device based on the user device being associated with (e.g., belongs to) the group of devices. The second network device may determine that the first network device is associated with the service entity based on the network address associated with a first network device. The second network device may determine that the first network device is associated with the service entity based on determining that the first network device is associated with (e.g., belongs to) the group of devices on the network to which the service entity provides preferential treatment (e.g., enhanced service flows). The second network device may establish at least one enhanced service flow between the second network device and the first network device based on (e.g., in response to) determining that the first network device is associated with the service entity. If the user device is connected to the first network device, establishing the at least one enhanced service flow between the second network device and the first network device may cause establishment of the at least one service flow between the user device and the second network device.

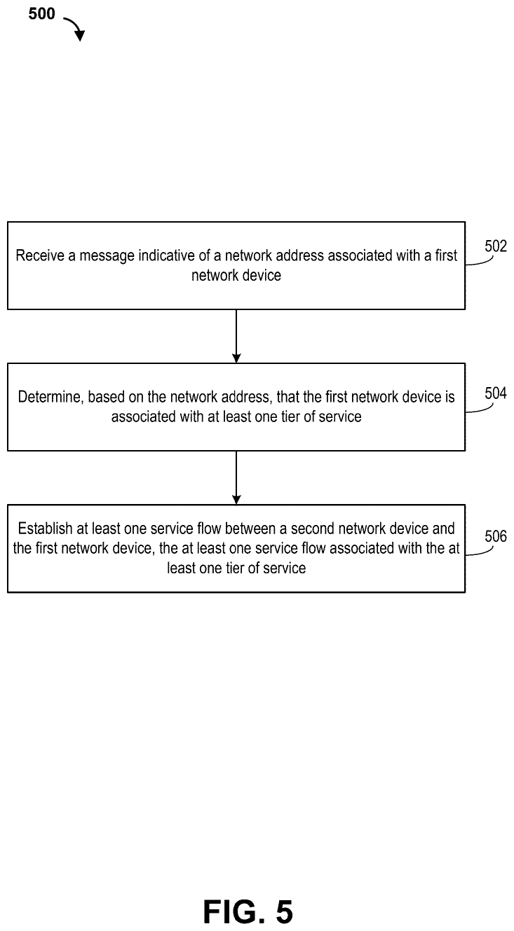

FIG. 5 is an example method 500. The method 500 may comprise a computer implemented method for connection management. A system and/or computing environment, such as the system 100 of FIG. 1 and/or the computing environment of FIG. 7, may be configured to perform the method 500. For example, the second network device 106 of FIG. 1 may be configured to perform the method 500.

At 502, a message may be received. The message may be indicative of a network address associated with a first network device. For example, the message may comprise data indicating a network address associated with a user device connected to the first network device. The network address associated with the user device may be indicative of the network address associated with a first network device. The first network device and the user device may be located at a premises. The network address associated with the first network device may comprise an IP address, such as an IPV6 address, of the first network device. The message may be received from a server device. The message may be received, such as from a server device, based on the server device determining that a user identifier (e.g., IMSI) associated with the user device is associated with at least one tier of service. For example, the message may be received from the server device based on the server device determining that the user identifier is associated with a group of devices on a network to which a service entity provides preferential treatment (e.g., one or more enhanced service flows).

At 504, it may be determined that the first network device is associated with the at least one tier of service. The network address associated with the first network device may be determined based on the network address associated with the user device. Determining that the first network device is associated with the at least one tier of service may comprise determining that the first network device is associated with (e.g., belongs to) a group of devices associated with the at least one enhanced service. It may be determined that the first network device is associated with the at least one tier of service based on the network address associated with the first network device. Determining that the first network device is associated with the at least one tier of service may comprise determining that the network address associated with the first network device is associated with a device that has been issued by the service entity.

At 506, at least one service flow may be established. The at least one service flow may be established between the second network device and the user device. The at least one service flow may be established between the second network device and the user device via the first network device. The at least one service flow may be associated with the at least one tier of service. The at least one service flow may be established based on the first network device being associated with the at least one tier of service. The at least one service flow may comprise a first enhanced service flow associated with upstream traffic (e.g., data sent from the user device and/or first network device to the second network device) and a second enhanced service flow associated with downstream traffic (e.g., traffic sent from the second network device to the user device and/or first network device).

The at least one service flow may be a “fast lane” (e.g., channel) that is free of congestion caused by other devices connected to the first network device and/or the second network device. The at least one service flow may be associated with at least one enhanced service provided by the service entity. The enhanced service(s) may comprise one or more of an increased download speed, an increased upload speed, a spam filtering service, a malware detection service, and a parental control service that limits access to certain types of content or content sources. Other devices that are connected to the first network device and/or the second network device but that do not receive preferential treatment from the service entity may not be able to take advantage of the enhanced service(s) provided via the local enhanced service flow(s).

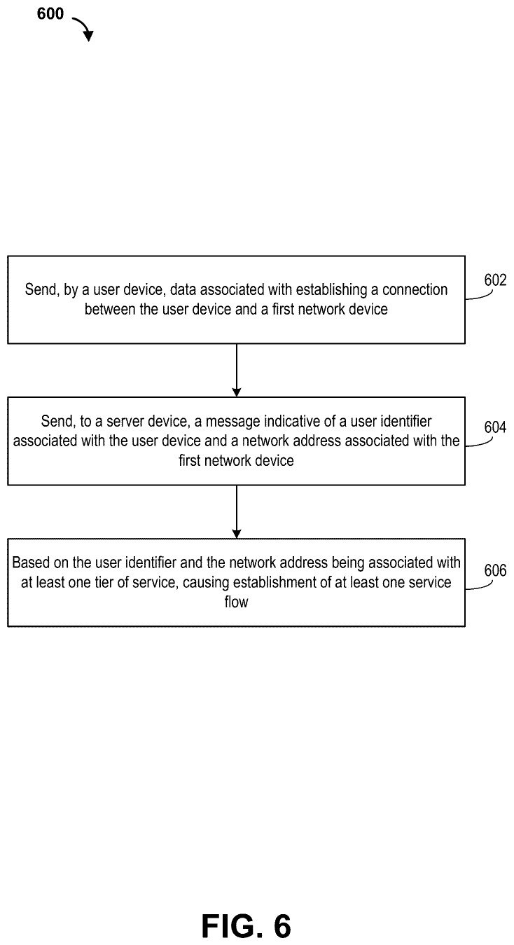

FIG. 6 is an example method 600. The method 600 may comprise a computer implemented method for connection management. A system and/or computing environment, such as the system 100 of FIG. 1 and/or the computing environment of FIG. 7, may be configured to perform the method 600. For example, the user device 102 of FIG. 1 may be configured to perform the method 600.

A user device and a first network device may be located at a premises. The premises may comprise a property, dwelling, terminal, building, floor, and/or the like. The premises may include an area within a coverage range (e.g., wireless range) of the first network device. At 602, data may be sent. The data may be associated with establishing a connection between the user device and the first network device. The data may be sent by the user device and to the first network device. The data may indicate a device identifier, such as a MAC address, associated with the user device. The user device may be associated with a temporary device identifier, such as a randomized or rotating MAC address. If the user device is associated with a temporary device identifier, the user device may send data indicating the current device identifier of the user device to the first network device. The first network device may establish the connection with the user device based on the data.

At 604, a message may be sent. The message may be indicative of a user identifier associated with the user device. The user identifier may comprise a subscriber identifier, such as an IMSI, associated with the user device. The IMSI may be stored on a SIM card, such as an eSIM or a physical SIM card, associated with the user device. The message may be indicative of a network address associated with the first network device. For example, the message may comprise data indicating a network address associated with the user device. The network address associated with the user device may be indicative of the network address associated with the first network device. The network address associated with the first network device may comprise an IP address, such as an IPV6 address, of the first network device. The message may be sent to a server device. The service device may be associated

The server device may receive the message. The server device may determine if the user device is associated with at least one tier of service. Determining if the user device is associated with the at least one tier of service may comprise determining if the user device is associated with (e.g., belongs to) a group of devices to which the service entity provides preferential treatment (e.g., one or more enhanced service flows). The server device may determine if the user device is associated with the at least one tier of service based on the user identifier of the user device. To determine if the user device is associated with the at least one tier of service, the server device may determine if the user identifier of the user device corresponds to the service entity. If the server device determines that the user device is associated with the at least one tier of service, the server device may send a message indicating the network address associated with the user device to the second network device.

The second network device may receive the message from the server device. The second network device may determine the network address associated with the first network device based on the network address associated with the user device. The second network device may determine if the first network device is associated with the at least one tier of service. Determining if the first network device is associated with the at least one tier of service may comprise determining if the first network device is associated with (e.g., belongs to) the group of devices based on the network address associated with the first network device. Determining if the first network device is associated with the group of devices may comprise determining if the network address associated with the first network device is associated with a device that has been issued by the service entity.

If the first network device is associated with the at least one tier of service, the second network device may establish at least one service flow (e.g., connection) between the second network device and the user device. At 606, establishment of at least one service flow between the user device and the second network device may be caused. Causing establishment of the at least one service flow between the user device and the second network device may comprise causing establishment of the at least one service flow between the user device and the second network device via the first network device. The at least one service flow may be associated with the at least one tier of service. The at least one tier of service may be associated with at least one enhanced service. Establishment of the at least one service flow may be caused based on the subscriber identifier and the network address being associated with a group of devices associated with at least one tier of service.

The at least one service flow may comprise a first service flow associated with upstream traffic (e.g., data sent from the user device/first network device to the second network device) and a second service flow associated with downstream traffic (e.g., traffic sent from the second network device to the user device/first network device). The at least one service flow may be a “fast lane” (e.g., channel) that is free of congestion caused by other devices connected to the first network device and/or the second network device. The at least one service flow may be associated with at least one enhanced service provided by the service entity. The enhanced service(s) may comprise one or more of an increased download speed, an increased upload speed, a spam filtering service, a malware detection service, and a parental control service that limits access to certain types of content or content sources. Other devices that are connected to the first network device and/or the second network device but that do not receive preferential treatment from the service entity may not be able to take advantage of the enhanced service(s) provided via the at least one service flow.

FIG. 7 depicts a computing device that may be used in various aspects, such as the servers and/or devices depicted in FIG. 1. With regard to the example architecture of FIG. 1, any of the components or devices may each be implemented in an instance of a computing device 700 of FIG. 7.

The computer architecture shown in FIG. 7 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 4-6.

The computing device 700 may include a baseboard, or “motherboard,” which is a printed circuit board to which a multitude of components or devices may be connected by way of a system bus or other electrical communication paths. One or more central processing units (CPUs) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s). The GPU(s) may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random access memory (RAM) 708 used as the main memory in the computing device 700. The chipset 706 may further provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems through local area network (LAN) 716. The chipset 706 may include functionality for providing network connectivity through a network interface controller (NIC) 722, such as a gigabit Ethernet adapter. A NIC 722 may be capable of connecting the computing device 700 to other computing nodes over a network 716. It should be appreciated that multiple NICs 722 may be present in the computing device 700, connecting the computing device to other types of networks and remote computer systems.

The computing device 700 may be connected to a mass storage device 728 that provides non-volatile storage for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 728 is characterized as primary or secondary storage and the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may further read information from the mass storage device 728 by detecting the physical states or characteristics of one or more particular locations within the physical storage units.

In addition to the mass storage device 728 described above, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described above. The computing device 700 may have access to computer-readable storage media storing computer-executable instructions, which, when executed by the computing device 700, may perform the methods described in relation to FIGS. 6-11.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by a computing device, a message indicative of a user identifier associated with a user device and a network address associated with a first network device located at a premises;
determining, based on the user identifier, that the user device is associated with at least one tier of service; and
causing, based on the network address associated with the first network device, establishment of at least one service flow between the user device and a second network device located external to the premises, wherein the at least one service flow is associated with the at least one tier of service.

2. The method of claim 1, wherein receiving, by the computing device, the message indicative of the user identifier associated with the user device and the network address associated with the first network device comprises receiving the message from the user device.

3. The method of claim 1, wherein determining, based on the user identifier, that the user device is associated with the at least one tier of service comprises determining that the user identifier corresponds to a service entity that provides the at least one tier of service to a group of devices.

4. The method of claim 1, further comprising:
determining, based on the user identifier, at least one service flow identifier associated with establishment of the at least one service flow.

5. The method of claim 1, wherein causing, based on the network address associated with the first network device, establishment of the at least one service flow between the second network device and the user device comprises sending the network address associated with the first network device to the second network device.

6. The method of claim 1, wherein the second network device is configured to establish the at least one service flow between the second network device and the user device based on determining that the network address associated with the first network device is associated with the at least one tier of service.

7. The method of claim 1, wherein the at least one service flow comprises a first service flow associated with upstream traffic and a second service flow associated with downstream traffic.

8. The method of claim 1, wherein the at least one tier of service is associated with one or more of an increased download speed, an increased upload speed, a spam filtering service, a malware detection service, or a parental control service.

9. The method of claim 1, wherein the user identifier comprises an international mobile subscriber identity (IMSI).

10. The method of claim 1, wherein the network address comprises an Internet Protocol (IP) address.

11. The method of claim 1, wherein the first network device comprises at least one of a router device, a gateway device, a computing device, or an access point, and wherein the second network device comprises at least one of a gateway device, a computing device, or an access point.

12. The method of claim 1, wherein the computing device comprises a server device located external to the premises.

13. A method comprising:
receiving, at a second network device located external to a premises, and based on a user identifier associated with a user device being associated with at least one enhanced tier of service, a message indicative of a network address associated with a first network device located at the premises, wherein the first network device is connected to the user device;
determining, based on the network address, that the first network device is associated with the at least one tier of service; and
establishing, based on the first network device being associated with the at least one tier of service, at least one service flow between the second network device and the user device, wherein the at least one service flow is associated with the at least one tier of service.

14. The method of claim 13, wherein the message comprises at least one service flow identifier associated with establishment of the at least one service flow, and wherein establishing the at least one service flow between the second network device and the user device is based on the at least one service flow identifier.

15. The method of claim 13, wherein establishing, based on the first network device being associated with the at least one tier of service, the at least one service flow between the second network device and the user device comprises establishing a first service flow associated with upstream traffic and a second service flow associated with downstream traffic.

16. The method of claim 13, further comprising:
determining, based on the network address, a device identifier associated with the first network device; and
causing storage of an association between the device identifier associated with the first network device and the at least one service flow.

17. A method comprising:
sending, by a user device located at a premises, data associated with establishing a connection between the user device and a first network device located at the premises;
sending, to a computing device, a message indicative of a user identifier associated with the user device and a network address associated with the first network device; and
based on the user identifier and the network address being associated with at least one tier of service, causing establishment of at least one service flow between the user device and a second network device located external to the premises, wherein the at least one service flow is associated with the at least one tier of service.

18. The method of claim 17, wherein the computing device is configured to determine, based on the user identifier, that the user device is associated with the at least one tier of service, and wherein the second network device is configured to determine, based on the network address, that the first network device is associated with the at least one tier of service.

19. The method of claim 17, wherein causing establishment of the at least one service flow between the user device and the second network device comprises causing establishment of a first service flow associated with upstream traffic and causing establishment of a second service flow associated with downstream traffic.

20. The method of claim 17, wherein the at least one tier of service is associated with one or more of an increased download speed, an increased upload speed, a spam filtering service, a malware detection service, or a parental control service.
